(19) United States
(12) Patent Application Publication
(10) Pub. No.: US 2016/0082427 A1
(43) Pub. Date: Mar. 24, 2016

(54) DESULFURIZATION OF NOX STORAGE CATALYSTS

(71) Applicant: UMICORE AG & CO. KG, Hanau-Wolfgang (DE)

(72) Inventors: Frank ADAM, Linsengericht (DE); Susanne KUNERT, Seeheim-Jugenheim (DE); Stephan ECKHOFF, Alzenau (DE); Christian LAMMARCK, Grosskrotzenburg (DE)

(73) Assignee: UMICORE AG & CO. KG, Hanau-Wolfgang (DE)

(21) Appl. No.: 14/787,123

(22) PCT Filed: Apr. 17, 2014
(86) PCT No.: PCT/EP2014/057860

§ 371 Date: Oct. 26, 2015

(30) Foreign Application Priority Data
Apr. 26, 2013 (DE) 10 2013 207 709.2

(51) Int. Cl. B01J 38/04; B01D 53/96; B01D 53/94; B01J 23/96

(52) U.S. Cl. CPC B01J 38/04; B01J 23/96; B01D 53/96; B01D 53/9422; B01D 2255/1021; B01D 2255/1023; B01D 2255/1025; B01D 2255/2065; B01D 2255/2042

(57) ABSTRACT

The present invention relates to the use of a particular method for the targeted desulfurization of particular nitric oxide storage catalysts (NOx storage catalysts). In particular, this invention is directed to the use of an adapted method on specifically composed storage catalysts.

The present invention relates to the use of a particular method for the targeted desulfurization of defined nitric oxide storage catalysts (NOx storage catalysts). In particular, this invention is directed to the use of an adapted method on specifically composed storage catalysts.

Future exhaust gas regulations will limit the amount of nitric oxides (NOx) in the exhaust gas of lean-burning engines to the extent that a catalytic after-treatment of the nitric oxides will become necessary. However, the intended reduction of nitric oxides to nitrogen is difficult due to the high oxygen content in the exhaust gas of lean-mixture-combustion engines. Known methods are based either on the use of nitric oxide storage catalysts (NOx storage catalyst, NSC, LNT) or are methods for selective catalytic reduction (SCR), mostly using ammonia as a reduction agent, on a suitable catalyst; in short, an SCR catalyst. Combinations of these methods are also known in which, for example, ammonia is produced as a secondary emission on an upstream nitric oxide storage catalyst under enriched operating conditions, which is first stored in an SCR catalyst arranged on the outlet side and used in a subsequent lean operating phase to reduce the nitric oxide passing the nitric oxide storage catalyst. DE 102007060623 A1 describes a series of variants—present in the prior art—of exhaust gas purification systems comprising denitrogenation systems.

Nitric oxide storage catalysts are already now being used for removal of the nitric oxides contained in the lean exhaust gas of what are known as lean burning engines (diesel, lean-GDI). In those cases, the purification function is based on the fact that, in a lean operating phase (storage phase, lean operation) of the engine, the nitric oxides are stored in the form of nitrates by the storage material of the storage catalyst. In a subsequent enriched operating phase (regeneration phase, rich operation, DeNOx phase) of the engine, the previously-formed nitrates are decomposed and the nitric oxides being released again are converted with the enriched components of the exhaust gas that act in a reducing manner into nitrogen, carbon dioxide and water at the storage catalyst. Hydrocarbons, carbon monoxide, ammonia and hydrogen acting in a reducing manner are, among others, designated as enriched components of the exhaust gas.

The method of operation of nitric oxide storage catalysts is comprehensively described in the SAE Publication SAE 950809. The composition of nitric oxide storage catalysts is sufficiently known to the person skilled in the art. The routinely-used nitric oxide storage materials generally include basic compounds of the alkali metals or alkaline earth metals such as, for example, oxides, hydroxides or carbonates of barium and strontium, which are applied to suitable substrate materials in finely dispersed form. Suitable substrate materials for the storage components are temperature-stable metal oxides having high surface area. In addition, a nitric oxide storage catalyst furthermore has catalytically active precious metals of the platinum group, and possibly oxygen storage materials (DE502006004606D1). This composition imparts to a nitric oxide storage catalyst the function of a three-way catalyst under stoichiometric operating conditions (DE102010033689A1 and the literature cited therein).

The storage phase for nitric oxides (lean operation) usually lasts 100 to 2,000 seconds and depends on the storage capacity of the catalyst and the concentration of nitric oxides in the exhaust gas. With older catalysts having reduced storage capacity, however, the duration of the storage phase may also decrease to 50 seconds or less. In contrast, the regeneration phase (enriched operation) is always significantly shorter and only lasts a few seconds (5 s-20 s). The exhaust gas exiting the nitric oxide storage catalyst during regeneration essentially no longer has any pollutants and is nearly stoichiometrically composed. Its air ratio λ (lambda: indicates the ratio of fuel to air in the exhaust gas—see below) is almost exactly 1 during this time. At the end of the regeneration phase, the released nitric oxides and the oxygen bound to the oxygen storage components of the catalyst no longer suffice to oxidize all enriched exhaust gas components. This leads to a breakthrough of these components through the catalyst, and the air ratio sinks to a value below 1 downstream of the nitric oxide storage catalyst. This breakthrough indicates the end of regeneration and may be detected after the storage catalyst with the help of a what is known as a lambda probe.

The functioning of nitric oxide storage catalysts is diminished by sulfur compounds contained in the fuel and motor oil. These components, mostly present in organic sulfur compounds, are largely converted in the combustion chamber of the engine into sulfur dioxide SO₂, which then reaches the nitric oxide storage catalyst together with the exhaust gas. Analogous to the storage mechanism for nitric oxides, SO₂ is oxidized to SO₃ on the catalytically-active components and then stored in the nitric oxide storage material with formation of the corresponding sulfates. With increasing storage of nitric oxides and sulfur oxides in the storage material, the storage capacity of the material decreases. As described, the nitrates formed by the storage of nitrates may be decomposed to nitric oxides (NOₓ) by means of the short-term enrichment of the exhaust gas and—with the use of carbon monoxide, oxygen and hydrocarbons as reducing agents—may be reduced to nitrogen with the formation of water and carbon monoxide. Since the sulfates formed by the storage of the sulfur dioxide are more thermally stable than the corresponding nitrates, the storage of sulfur oxides at normal operating conditions leads to a poisoning of the nitric oxide storage catalyst, which even under reducing exhaust gas conditions is generally reversible only at high temperatures. Given high sulfur content in the fuel (>10 ppm), nitric oxide storage catalysts must therefore likewise be frequently desulfurized. For this, the exhaust gas must be brought to desulfurization conditions, i.e. it must be enriched and its temperature increased. The air ratio lambda (λ) of the exhaust gas should be reduced to a value under 0.98, preferably reduced to under 0.95, and the exhaust gas temperature should be brought to a value between 600 and 750° C. Under these conditions, the formed sulfates will decompose and be emitted as hydrogen sulfide, or preferably as sulfur dioxide (DE502007006908 D1).

When loading a nitric oxide storage catalyst with a sulfur-containing exhaust gas, in addition to regular regeneration for purposes of removing the stored nitrogen oxides the storage catalyst must therefore also be desulfurized from time to time in order to reverse a continuous deterioration of the nitric oxide storage capacity by formed sulfates. The interval between two desulfurizations depends on the sulfur content of the fuel, but even with high sulfur content generally amounts to several operating hours of the engine and is thus significantly greater than the interval between two regenerations for removal of the stored nitric oxide. Generally, the desulfurization requires from 2 to 10 minutes. Thus, it also lasts longer than the nitric oxide regeneration of the storage catalyst.

The frequent desulfurization takes place at the expense of fuel consumption and, due to the necessarily high exhaust gas temperature, leads to rapid aging of the catalysts. For that reason, motor vehicles with lean-burning gasoline engines have to date been sold only on the European market, since fuels with a sulfur content of less than 10 ppm are offered here. While exhaust gas legislation in the USA is indeed particularly strict, the sulfur content of the fuel for gasoline engines here is currently still up to 30 ppm. In other regions, the sulfur content of fuels is markedly higher still.

The development of motor vehicles having lean-burning gasoline engines for markets with high sulfur content in the fuel must therefore take into consideration the fact that, in this case, the nitric oxide storage catalysts must be desulfurized frequently. In addition to the previously-mentioned disadvantages of frequent desulfurization—namely the increased fuel consumption and the high temperature load on the catalysts—a further disadvantage emerges in the increased emission of hydrocarbons and nitric oxides during desulfurization since, during the desulfurization, the enriched exhaust gas contains high concentrations of unburned hydrocarbons, carbon monoxide and nitric oxides, as well as ammonia formed on the catalysts from the nitric oxides, but hardly any oxygen to convert these exhaust gas components on the catalysts. Thus, they are emitted unpurified to the environment as pollutants.

However, the American exhaust gas emission laws provide that the otherwise very low threshold values for hydrocarbons, carbon monoxide and nitric oxides must be complied with, even taking the desulfurization of the nitric oxide storage catalysts into consideration. For this purpose, the emissions during desulfurization of nitric oxide storage catalysts are allocated to the total operating cycle provided for the emissions measurements. It has been shown that the emissions even during a single desulfurization of nitric oxide storage catalysts may exceed the prescribed threshold values for what are known as SULEV vehicles (SULEV=super ultra low emission vehicle).

Research in respect to the development of new nitric oxide storage catalysts thus is headed in the direction of developing storage media which may be more easily desulfurized—that is to say, at lower temperatures and with decreased emission of pollutants. WO08043604A1 is a starting point in this direction. The present invention presents a method via the use of which the desulfurization temperature of conventional nitric oxide storage catalysts comprising a platinum component and at least one nitric oxide storage material may be reduced. In this, the basicity of the chemical environment of the platinum is reduced, while the nitric oxide storage material as such may remain unchanged. Furthermore, an improved nitric oxide storage catalyst having reduced desulfurization temperature resulting from the use of this method is presented. Such catalysts are particularly suited for the nitric oxide after-treatment of the exhaust gas from diesel motors. However, even with these storage catalysts, a temperature in excess of 550° C. is still required in order to ensure an adequate extraction of sulfur.

Thus, it was the object of the present invention to demonstrate additional possibilities of how otherwise comparably good nitric oxide storage catalysts may be regenerated effectively and with the greatest possible fuel savings. This and other objects emerging from the prior art are achieved via the use of a particular method for the desulfurization of specially-designed nitric oxide storage catalysts according to claim 1. Preferred embodiments of the method according to the invention are addressed in the subordinate claims depending on claim 1.

As a result of using a method for the targeted desulfurization of NOx-storage catalysts which are used to purify the exhaust gas of predominantly lean-burning gasoline engines, and which have cerium and alkaline earth metal-containing nitric oxide storage materials, wherein the NOx-storage catalysts have a ratio by weight of cerium-containing nitric oxide storage materials to alkaline earth metal-containing ones of 10:1 to 20:1 (relative to CeO₂:alkaline earth metal oxide), and these are desulfurized at increased temperatures of ≧500° C. in the middle of the A/F-range of 0.98≦λ≦1.0, the achievement of the object presented is reached surprisingly simple, and no less advantageous for that. It has turned out that the described method for desulfurization of nitric oxide storage materials is used particularly well on storage catalysts whose storage components are mostly, but not exclusively, formed from cerium-containing storage modules. In the NF ranges according to the invention, the nitric oxide storage catalyst works as a three-way catalyst, such that the primary exhaust gases exit the exhaust gas purification mostly as carbon dioxide, water and nitrogen. An additional fuel-intensive heating and simultaneous enrichment of the exhaust gas, as is unavoidable with normal nitric oxide storage catalysts, can be omitted in certain operating situations (freeway driving). Here, the nitric oxide storage catalyst is already sufficiently hot. The desulfurization may be efficiently performed via the targeted adjustment of a stoichiometric to very lightly enriched exhaust gas mixture. On the one hand, this helps to save fuel. But it has nevertheless also been found that, under the proposed conditions, the sulfur contained in the nitric oxide storage catalysts is mostly emitted as SO₂. Any foul odors caused by the H₂S normally formed during regeneration is thus suppressed as much as possible.

Nitric oxide storage catalysts have been known to the person skilled in the art for a long time. In respect to their operation and configuration, reference is made to the applicable literature (WO13008342A1, WO12140784A1, WO2005092481A, EP1317953A1, EP1016448B1, EP1321186B1, EP1911506A and EP1101528A). The basic oxides of the alkali metals, the alkaline earth metals (but particularly barium oxide) and the rare earth metals (particularly cerium oxide) which react with nitrogen dioxide to form the corresponding nitrates are predominantly used as storage components in nitric oxide storage catalysts. The cerium-containing storage material in question is preferably one selected from the group comprising cerium oxide, a cerium-zirconium mixed oxide, a cerium oxide doped with rare earths, and combinations thereof. A doping of the cerium-zirconium mixed oxide with 0.5 to 10 wt % lanthanum and/or praseodymium oxide, relative to the total weight of the cerium-zirconium mixed oxide and lanthanum and/or praseodymium oxide, is preferentially performed. Preferred basic storage materials—such as, for example, alkaline earth metal-containing nitric oxide storage materials—are compounds containing Mg, Ba, Sr, Ca. It is known that these materials are present in air, mostly in the form of carbonates and hydroxides. These compounds are likewise suited to the storage of nitric oxides. Thus, when the basic alkaline earth metal-containing storage materials are mentioned within the scope of the invention, the corresponding carbonates and hydroxides are also included with these. The precious metals of the platinum group (for example Pt, Pd, Rh) are usually used as the catalytically active components which, like the storage components, are deposited on a substrate material. Suitable substrate materials for the components are temperature-stable metal oxides having a high surface area of more than 10 m²/g, which allow a highly dispersed deposition of the storage components. For example, cerium oxide and cerium-containing mixed oxides, aluminum oxide, magnesium oxide, magnesium-aluminum mixed oxides, rare earths and some ternary oxides are suitable. Active, high surface area aluminum oxide is overwhelmingly used as substrate material. The nitric oxide storage catalyst that is advantageously usable via application of the described method is, in its preferred embodiments, applied as a wall coating to an inert substrate body made of ceramic or metal. Flow-through honeycomb bodies made from ceramic or metal are well suited as substrate bodies for automotive applications. The nitric oxide storage catalyst envisaged herein may be present on or in a particle filter as a substrate body (EP1837497A1, EP1398069A2, DE102009039249A). The term “on or in” thus refers to the possibility of a coating on the wall or in the porous cavities of the same.

Besides the storage materials addressed above, the present nitric oxide storage catalysts, as mentioned, also comprise precious metals. With respect to the amount and type, the person skilled in the art will be guided by the prior art set forth in the introduction to catalysts. Those precious metals selected from the group comprising palladium, platinum and rhodium are preferentially used. The proportions may correspondingly be selected by the person skilled in the art according to his state of knowledge, the platinum content in the storage material being advantageously 30-150, preferably 40-100, and most preferably 50-70 g/cft. With respect to palladium, values result to 10-150, preferably 20-100 and most particularly preferably 30-80 g/cft. Likewise, rhodium is present in the catalytic material in an amount of 0.5-10, preferably 1-8, and most preferably 1-5 g/cft. The ratio of the metals to one another is 50-100:10-50:1-5 (Pt:Pd:Rh), preferably 70-90:12-30:2-4 and particularly preferably 80:16:3 (each ±10%).

According to the invention, the proposed nitric oxide storage catalyst possesses a specific ratio of cerium-containing storage materials to alkaline earth metal-containing ones. The ratio of 10:1 to 20:1 thus refers to the weight of the oxides of these two components (CeO₂:alkaline earth metal oxide). The ratio is preferably 12:1 to 19:1 and is most particularly preferably between 12.5:1 and 18:1. Desulfurization of a nitric oxide storage catalyst constructed in such a manner already occurs at temperatures of ≧500°-800° C., preferably 550°-700° C., and most particularly preferably between 600° C. and 650° C.

The targeted desulfurization according to the invention is accomplished at a specific air/fuel ratio (air ratio, A/F-ratio). The combustion air ratio (A/F) sets the volume of air actually available for combustion (m_{L,tats}) in relationship to the stoichiometrically smallest necessary volume of air (m_{L,st}) required for complete combustion:

$$λ = \frac{{m}_{L , tats}}{{m}_{L , st}}$$

If the air ratio is λ=1, then that ratio is considered the stoichiometric combustion air ratio with m_{L,tats}=m_{L,st}; that is the case if all fuel molecules theoretically react completely with the atmospheric oxygen, without any deficiency of oxygen, or any unburned oxygen remaining.

For combustion engines this means:

λ<1 (e. g. 0.9) means “air shortage”: rich or even too-rich mixture

λ>1 (e. g. 1.1) means “air excess”: lean or even poor mixture

Predicate: λ=1.1 means that 10% more air participates in combustion than would be required for a stoichiometric reaction. This is coincidently the air excess.

According to the invention, the present method is performed at an air ratio between 0.98≦λ≦1.0, preferably at 0.99≦λ≦1.0 and most particularly preferably at 0.995≦λ≦1.0. In this way, and via the use of the said nitric oxide storage catalysts, the emission of hydrogen sulfide is markedly reduced (FIG. 1). In doing this, it is particularly advantageous if the adjusted air ratio is modulated using a specific frequency during desulfurization. This frequency is advantageously between 0.5-20, preferably between 1-12 and most particularly preferably between 1-5 Hz. At the same time, it is advisable to perform the modulation in respect of the air ratio at an amplitude within a range of ±0.05, preferably ±0.01, and most particularly preferably within a range of ±0.005.

Using the proposed storage catalysts and the method adapted to them—particularly with the assistance of the above-described modulation—it is possible to perform the targeted desulfurization under the operating conditions of lean-burning combustion engines, which are closely modeled on the normal operating conditions of a corresponding vehicle. The A/F ranges proposed in the method are almost automatically reached within the high performance range of these types of engines (e.g. fast freeway driving), which is why desulfurization at the temperatures then prevailing can automatically take place simultaneously with only modest additional measures. Thus, in such a way it is accordingly possible and especially advantageous to achieve a sufficient desulfurization of the nitric oxide storage catalyst without the necessity of additionally heating the exhaust gas to be desulfurized by means of the engine. In particular, the exhaust gas does not need to be additionally enriched for sufficient desulfurization of the nitric oxide storage catalysts in order to thus bring the temperature of the storage catalyst to the desulfurization temperature. In such operating situations, the targeted and also sufficient desulfurization according to the invention may then extremely preferably occur if the lean-burning gasoline engine is operated close to the above-stated A/F range. According to the invention, “sufficient” is understood to mean a degree of desulfurization of >50%, preferably >60% and especially preferably >70% relative to the sulfur stored in the catalyst.

A most preferred embodiment of the present invention is formed by a method in which a specific sequence of the following method steps is complied with for desulfurization. It has proven to be advantageous if at least 4 operating phases of the engine alternate, in which a lean phase is followed by a desulfurization phase (λ=0.995-1.0 (amplitude within ±0.005)) and in which the individual operating phases have a duration in the range from 5-30 min. Preferentially, the lean operating phase may optionally be shorter than the desulfurization phase by a factor of 2-6. Particularly preferred in this context is a sequence of operating phases for desulfurization as follows:
lean mode of operation for at least 5-10 min;
A/F=0.995-1.0 (amplitude within ±0.005) for at least 10-20 min;
lean mode of operation for at least 2-5 min;
A/F=0.995-1.0 (amplitude within ±0.005) for at least 10-30 min;

Using such a desulfurization strategy, it is possible to free the nitric oxide storage catalyst of stored sulfur oxides optimally and effectively, but at least sufficiently. It is noted that with such a method the sulfur is emitted mostly as sulfur dioxide, and thus this process does not lead to a foul odor caused by formed H₂S. The desulfurization strategy proposed here is preferably carried out within a temperature interval of 600° C. to 650° C.

It is noted that, in NOx-storage catalysts, CeO₂ is used both as carrier oxide as well as NOx-storage material. As far as the ratio of CeO₂:alkaline earth metal oxides is considered presently, only such CeO₂ which is capable of storing NOx to a sufficient degree is contemplated herein. For example, this is not the case if the CeO₂ is present in, for example, a spinel structure with other oxides, e.g. MgO or Al₂O₃. Therefore, only a CeO₂ storage material which is capable of storing at least 2, preferably at least 3 and most preferably at least 3.5 mg NOx/g relative only to the cerium oxide at T<200° C. is considered sufficient.

Using the nitric oxide storage catalyst proposed here, it is possible to achieve a sufficient desulfurization near the stoichiometric point, which is correspondingly hardly possible with normal nitric oxide storage catalysts in which the ratio of cerium-containing storage materials to alkaline earth metal-containing ones in oxidic form is <10:1. The desulfurization rate (speed of the sulfur discharge) of a nitric oxide storage catalyst having a ratio of cerium-containing storage materials to alkaline earth metal-containing ones of 10:1 to 20:1 (in test catalyst 2—CeO₂:alkaline earth metal oxide weight ratio of 12.5:1) at temperatures of 600° C.-650° C. and an air ratio of λ=1 is preferably greater by a factor of two, preferably a factor of three and most particularly preferably a factor of four than with a nitric oxide storage catalyst having a corresponding ratio of, e.g. 9.4:1 (catalyst 1) (FIG. 1). At the same time it is to be pointed out that the nitric oxide storage catalysts proposed here have a storage window for NOx that is shifted to lower temperatures (FIG. 2), which indicates that the sulfur oxides may also be stored and even desorbed at lower temperatures. This is particularly advantageous against the backdrop of the increasingly cooler combustion of even lean-burning gasoline engines. It is to be noted that, with the envisaged nitric oxide storage catalysts, no loss in terms of NOx performance is reported (FIG. 3).

Using the present method it is possible to desulfurize certain storage catalysts in a targeted and particularly advantageous manner. This is important in terms of fuel consumption. The targeted desulfurization preferably occurs during normal operating situations which require a hot exhaust gas. Thus, no extra heating of the nitric oxide storage unit is necessary. The generation of foul smelling hydrogen sulfide is also largely suppressed. Against this backdrop, the method according to the invention appears to be particularly advantageous, although it is not at all made obvious from the known prior art.

### FIGURES

FIG. 1: Desulfurization behavior in the 600-650° C. temperature window of both catalysts (catalyst 1 and catalyst 2) at lambda>1, lambda=1 and lambda=0.9

FIG. 2: NOx-storage window of the tested catalysts; catalyst 2 shows better NOx conversion at lower temperatures.

FIG. 3: Absolute conversion of harmful gases (raw emissions) by catalysts 1 and 2.

### EXAMPLES

To make catalyst 2, a honeycomb-shaped ceramic substrate was coated with a first wash-coat layer A containing Pt, Pd and Rh supported on a lanthanum-stabilized aluminum oxide, cerium oxide in an amount of 116 g/l, as well as 17 g/l if barium oxide and 15 g/l of magnesium oxide. The load of Pt and Pd is thus 50 g/cft (1.766 g/l) and 5 g/cft (0.177 g/l), and the total load of the wash-coat layer is 181 g/l relative to the volume of the ceramic substrate. An additional wash-coat layer B is applied to the first wash-coat layer, which additional wash-coat layer B likewise contains Pt and Pd as well as Rh supported on a lanthanum-stabilized aluminum oxide. The load of Pt, Pd and Rh in this wash-coat layer is 50 g/cft (1.766 g/l), 5 g/cft (0.177 g/l) and 5 g/cft (0.177 g/l). The wash-coat layer B additionally contains 93 g/l cerium oxide for a layer B wash-coat load of 181 g/l.

Catalyst 1, as specified in WO2008043604 (Example 1), is made in such a way that the ratio of CeO₂:BaO in the storage components is 9.4:1. The amount of BaO used is 17 g/l.

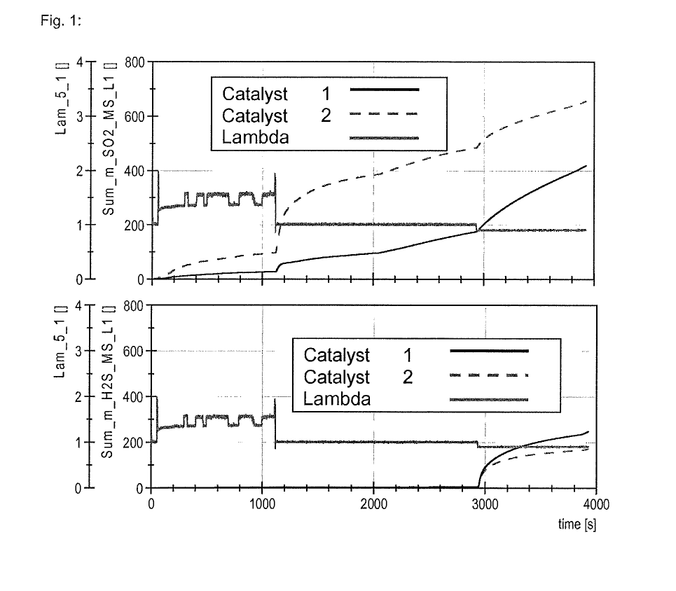

Description of the Experiment for FIG. 1

The testing method is conducted on a high dynamic engine test bench. The engine is a direct-injection gasoline engine with spray-guided, stratified charge combustion process. Using highly sulfured fuel (200 ppm sulfur), respectively defined amounts of sulfur are applied to the catalyst (SOx method) at a constant engine operating point and moderate catalyst temperatures (250-350° C.).

Subsequently, the desulfurization temperature (DeSOx-temperature 600-650° C.) is adjusted using a given load/rotational speed collective. In order to ensure that sulfur was not already being released during the heating phase, the temperature adjustment is made at lambda>>1. Upon reaching the DeSOx temperature, different lambda settings (constant as well as rich/lean variations) are adjusted. The respectively set lambda value is held constant over a specified time interval. During this, released sulfur components are recorded using FTIR (DeSOx method).

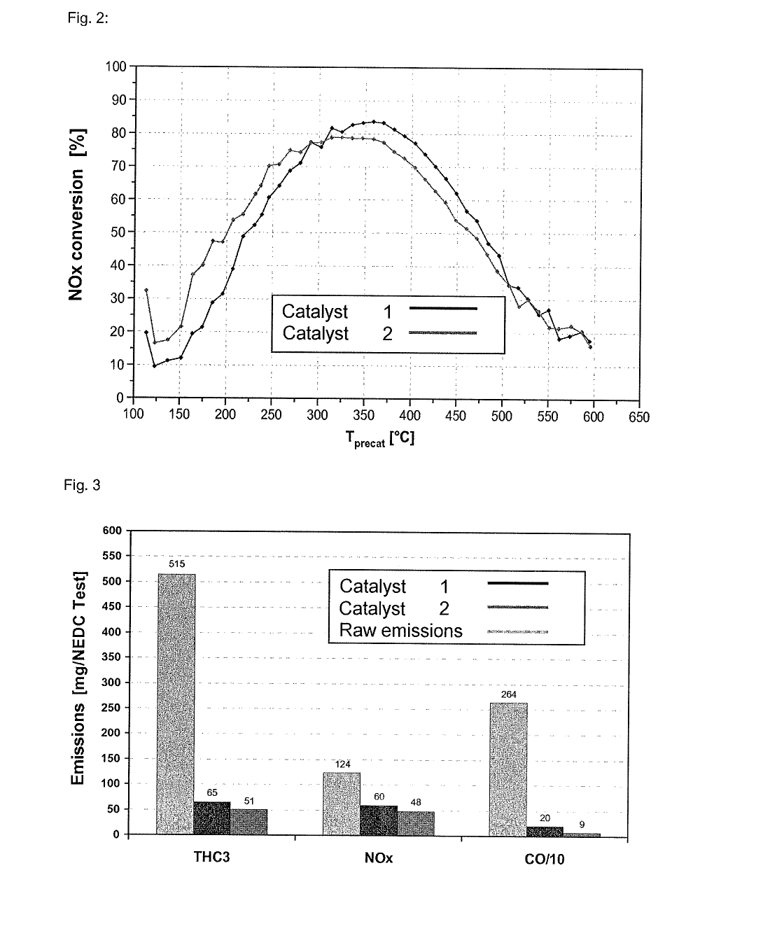

Description of the Experiment for FIG. 2

The testing method is conducted on a dynamic synthesis gas apparatus using synthetically produced exhaust gas. In the experiment, the heated catalyst 1 or 2 is cooled at a rate of 7.5° C./min. During the cooling procedure, alternation takes place between storage and regeneration (extraction) in a specified time window. The NOx concentration, specified in this case as a constant, is 500 ppm. The evaluation in each case occurs over a lean/rich cycle and shows the conversion as a function of the catalyst temperature and relative to the initial concentration of 500 ppm NOx.

Description of the Experiment for FIG. 3

The testing method is conducted on a high dynamic synthesis gas apparatus. Here, an automobile emissions profile (emissions, temperatures, mass flows, catalyst volumes of the vehicle, etc.) was transferred (applied) to the synthesis gas apparatus in a specified scale of 1:5-1:50, and both catalysts (1 and 2) were tested for conversion behavior. It has been proven in various cross-comparisons between synthesis gas apparatuses and vehicles that the conversion behavior correlates well at the corresponding scale.

1. Use of a method for the targeted desulfurization of NOx storage catalysts which are used for exhaust gas purification of predominantly lean-burning combustion engines, wherein the NOx storage catalysts comprise cerium and alkaline earth metal-containing nitric oxide storage catalysts in a weight ratio of cerium-containing nitric oxide storage catalysts to alkaline earth metal-containing ones of 10:1 to 20:1, wherein these are desulfurized at ≧500° C. on average in an A/F range of 0.98≦λ≦1.0.

2. The use according to claim 1, wherein the NOx storage catalysts comprise cerium-containing nitric oxide storage catalysts selected from the group comprised of cerium oxide, a cerium-zirconium mixed oxide, a cerium oxide doped with rare earths, and combinations thereof.

3. The use according to claim 1, wherein the NOx storage catalysts comprise alkaline earth-containing nitric oxide storage materials, wherein the alkaline earth metals in these materials are selected from the group comprised of barium, calcium, strontium, and magnesium.

4. The use according to claim 1, wherein the temperature during the desulfurization is 500° C. to 800° C.

5. The use according to claim 1, wherein, the adjusted air ratio during desulfurization is modulated using a frequency between 0.5 and 20 Hz.

6. The use according to claim 5 wherein, during the desulfurization the modulation is performed at an amplitude within ±0.05 of the adjusted air ratio (λ).

7. The use according to claim 1, wherein, the exhaust gas for the desulfurization of the nitric oxide storage catalysts is not additionally enriched by means of the engine in order to thereby bring the temperature up to the desulfurization temperature.

8. The use according to claim 7, wherein, the desulfurization is performed during normal operating situations, wherein the lean-burning gasoline engine is operated within the A/F range 0.98≦λ≦1.0.

9. The use according to claim 1, wherein at least 4 operating phases of the engine rotate alternately, wherein a lean phase is followed by a desulfurization phase (λ=0.995-1.0 (amplitude within ±0.005)) and in which the individual operating phases have a duration in the range from 5-30 min.
